(19) United States
(12) Patent Application Publication
(10) Pub. No.: US 2022/0193930 A1
(43) Pub. Date: Jun. 23, 2022

(54) ROBOTIC SYSTEM AND METHODS FOR PICKING UP AND MOVING OBJECTS

(71) Applicant: Glacier Technology Inc., San Francisco, CA (US)

(72) Inventors: Areeb Malik, San Francisco, CA (US); Emily Porter, Chapel Hill, NC (US); Rebecca Hu, San Francisco, CA (US)

(21) Appl. No.: 17/560,886

(22) Filed: Dec. 23, 2021

Related U.S. Application Data
(60) Provisional application No. 63/130,076, filed on Dec. 23, 2020.

(51) Int. Cl. B25J 17/02; B25J 9/10; B25J 9/00

(52) U.S. Cl. CPC B25J 17/0233; B25J 9/1065; B25J 9/026; B25J 9/0093; B25J 9/104

(57) ABSTRACT

A catching mechanism includes an end effector and a return mechanism coupled to the end effector. The catching mechanism has a defined field of motion that permits the end effector to move in at least one dimension. The return mechanism is configured to return the catching mechanism to a predetermined starting position in which the catching mechanism is not being moved by a force away from the predetermined starting position.

### CROSS-REFERENCE TO RELATED APPLICATIONS

This application claims benefit of co-pending U.S. Provisional Patent Application No. 63/130,076, filed on Dec. 23, 2020, the entire contents of which is incorporated herein by reference.

### FIELD OF INVENTION

One technical field of the present disclosure is mechanical devices for picking up objects. Another technical field is robotic systems using techniques based on two-dimensional Cartesian designs to grasp a moving object.

### BACKGROUND

Robotic systems are used in many industries to perform simple repetitive tasks such as grasping, picking up, and moving objects. The installation of such systems offers many benefits, which include lower financial cost to perform basic tasks, as well as mitigation of physical risk to humans from performing such tasks in dangerous environments, such as manufacturing, warehousing, or waste processing facilities.

In a basic use case, a robotic system may be used to pick up homogenous static objects, such as pallets stacked in a pile. In a more complex use case, a robotic system may be used to pick up moving objects that are heterogeneous in size, shape, and placement, such as mixed refuse moving on a conveyor belt in a recycling or waste handling facility. Robots of the current art are often large, complex, and expensive to build. Therefore, a need exists for a robotic system that is able to pick up heterogenous moving objects, but that is smaller and less mechanically complex than the robotic systems commonly used today. A smaller, simpler system is much more viable than robots of the current art, both because of its lower cost and because it would be significantly easier to install.

### SUMMARY

In one construction, the invention provides a catching mechanism including an end effector and a return mechanism coupled to the end effector. The catching mechanism has a defined field of motion that permits the end effector to move in at least one dimension. The return mechanism is configured to return the catching mechanism to a predetermined starting position when the catching mechanism is not being moved by a force away from the predetermined starting position.

In another construction, the invention provides a robotic system for picking up objects including a catching mechanism and a robotic frame. The catching mechanism includes a return mechanism and an end effector movable from a starting position when the end effector makes contact with a target object. The robotic frame is configured to move the at least one catching mechanism to a predetermined position in order to make initial contact with the target object. The robotic frame moves the catching mechanism to a predetermined position such that the catching mechanism can sustain contact with the target object for a period of time to grasp the target object. The return mechanism is configured to return the catching mechanism back to the starting position if the end effector moves during the sustained contact with the target object.

In yet another construction, the invention provides a robotic grasping system for picking up objects including a first rail, a first carriage movably mounted to the first rail, a second carriage mounted to the first carriage, a second rail movably mounted to the second carriage, and a catching mechanism coupled to an end portion of the second rail. The first carriage is movable in a first dimension. The second rail is movable in a second dimension that is different from the first dimension. The catching mechanism is configured to engage with a target object moving in a third dimension which is different from the first dimension and the second dimension.

### BRIEF DESCRIPTION OF THE DRAWINGS

FIG. 1 is a perspective view of a robotic grasping system, illustrating an end effector of the robotic grasping system grasping a target object from a moving conveyor belt, according to a first embodiment.

FIG. 2 is a perspective view of a portion of the robotic grasping system of FIG. 1, illustrating the end effector movably coupled to a rail.

FIG. 3 is a perspective view of a first embodiment of a catching mechanism including the end effector of FIG. 1.

FIG. 4 is a side view of the end effector of FIG. 3 in a first, starting position.

FIG. 5 is a side view of the end effector of FIG. 3 in a second, maximum extended position.

FIG. 6 is a schematic view of an electronic controller of the robotic grasping system of FIG. 1.

FIG. 7 is a perspective view of a second embodiment of a catching mechanism using a rail, motor and pulley configuration.

FIG. 8 is a front view of the catching mechanism of FIG. 6 with an end effector in a first, starting position.

FIG. 9 is a front view of the catching mechanism of FIG. 6 with the end effector in a second, maximum extended position.

FIG. 10 illustrates part of the return movement of the end effector of FIG. 8 to the starting position.

FIG. 11 illustrates another part of the return movement of the end effector of FIG. 8 to the starting position.

FIG. 12 is a perspective view of another robotic grasping system according to a second embodiment, and including a multi-robot sorting system.

FIG. 13 is a perspective view of yet another robotic grasping system according to a third embodiment, and including a multi-robot sorting system.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps. Nevertheless, the specification and claims should be read with the understanding that such combinations are entirely within the scope of the invention and the claims.

In one embodiment, a robotic grasping system is disclosed. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of embodiments, and is not intended to limit the scope of the invention to the specific embodiments illustrated by the figures or description below. Other embodiments may be implemented in many different forms and should not be construed as limited to the examples set forth herein.

Embodiments are now described by referencing the appended drawing figures.

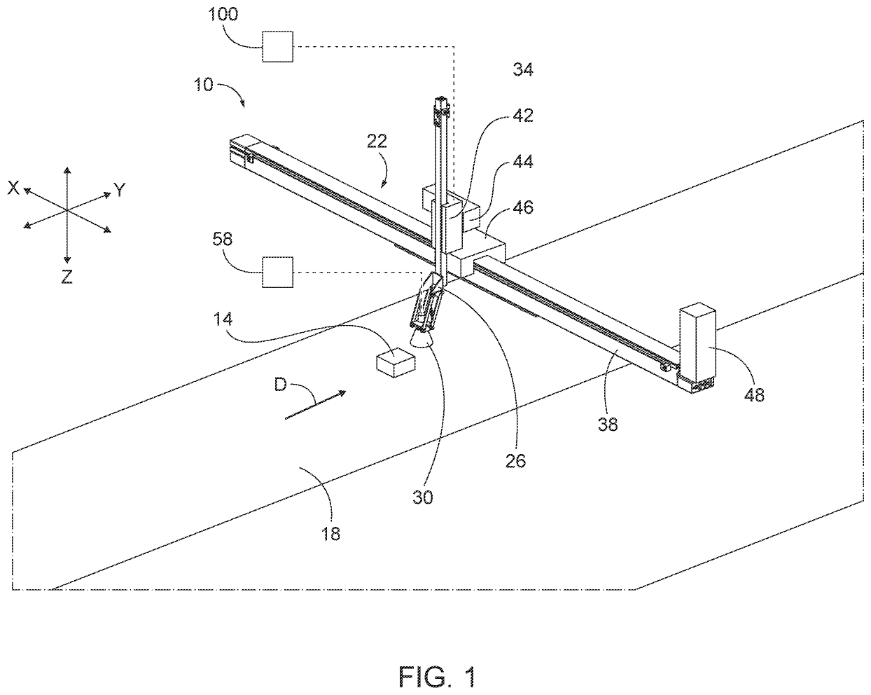

FIG. 1 illustrates one embodiment of a robotic system 10, or robotic grasping system, or robot. The robotic system 10 is for picking up objects. Specifically, the robotic system is for picking up moving objects. The robotic system 10 may be used for picking up target objects from a moving conveyor belt 18, but may be configured for other uses in other embodiments. The conveyor belt 18 moves the target objections in a direction D1 along a Y-dimension. The robotic system 10 includes a rail system 22 and a catching mechanism 26 operatively coupled to the rail system 22. The catching mechanism 26 includes an end effector 30 for picking up a target object 14. In some constructions, the end effector 30 includes at least one of any of a suction cup, claw, spike, jamming gripper, or other mechanism configured for grasping objects. The illustrated rail system 22 includes a first or Z-dimension rail 34 and a second or X-dimension rail 38. In the illustrated embodiment, the catching mechanism 26 is coupled to the Z-dimension rail 34, and the Z-dimension rail 34 is movably coupled to a Z-dimension carriage 42. In addition, the Z-dimension carriage 42 is fixedly coupled to an X-dimension carriage 48 that is movable relative to the X-dimension rail 38. As such, the catching mechanism 26 is capable of moving up and down (in the Z-dimension), and side to side (in the X-dimension) from the frame of reference of FIG. 1 by the rail system 22. In other embodiments, the Z-dimension rail (instead of the Z-dimension carriage) may be mounted to the X-dimension carriage. Other embodiments of the robotic system may not rely on rails or carriages for movement, such as a two-dimensional Delta robot.

In some constructions, the Z-dimension carriage or rail is mounted to the X-dimension carriage on the X-dimension rail that allows the Z-dimension rail to move side-to-side (the X-dimension). This forms a two-dimensional frame of the robot, which can move in the X- and Z-dimensions. The catching mechanism 26 is coupled to an end portion 70 of the Z-dimension rail and is capable of engaging with target objects 14 moving in the Y-dimension (front and back) despite the Z-dimension rail itself being unable to move in the Y-dimension and the X-dimension rail itself being unable to move in the Y-dimension.

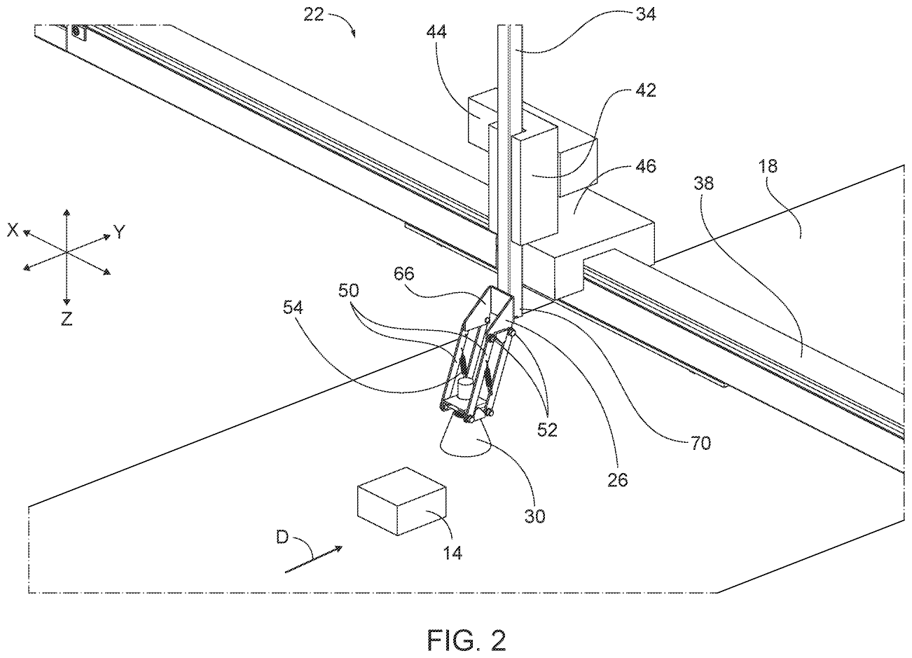

More specifically, as seen in close-up view in the embodiment depicted in FIG. 2, the catching mechanism 26 is coupled to the vertical Z-dimension rail 34 that is movably coupled to the Z-dimension carriage 42 for allowing movement of the catching mechanism 26 in the up and down direction. Control of the Z-dimension rail's movement relies on a movement system 44 such as motors, hydraulics, or pneumatics. The movement of the Z-dimension rail 34 may be determined by automated or manual controls.

Control of the X-dimension movement relies on a movement system 48 that may or may not be the same as the movement system 44 that manipulates the Z-dimension movement. Like the Z-dimension's movement system 44, the X-dimension movement system 48 may be operated by automated or manual controls.

The rail system 22 allows the catching mechanism 26 to be positioned at a predetermined height (Z-dimension) and predetermined longitude (X-dimension) to allow the end effector 30 to make initial contact with the target object 14 moving in the front and rear dimension (the Y-dimension) when the target object 14 passes under the catching mechanism 26. As such, the predetermined height and the predetermined longitude defines a predetermined position of the end effector 30. The end effector's 30 predetermined position may be determined in many ways including, but not limited to, an automated system or manual controls. For example, the robotic system 10 may include one or more sensors for determining the predetermined position of the end effector based on the movement of the target object. Other embodiments may not require Z-dimension and/or X-dimension movement.

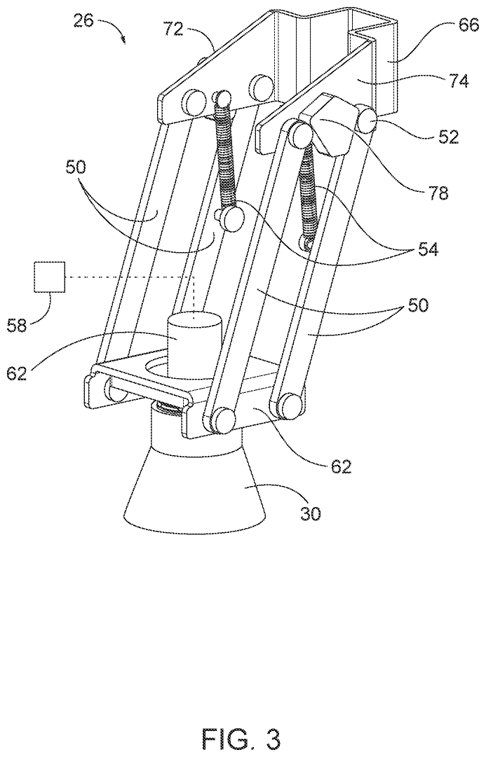

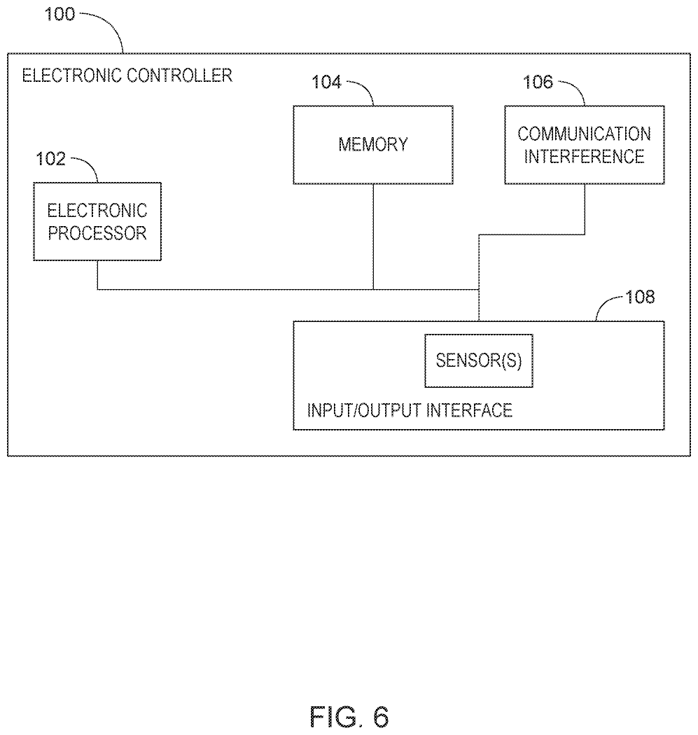

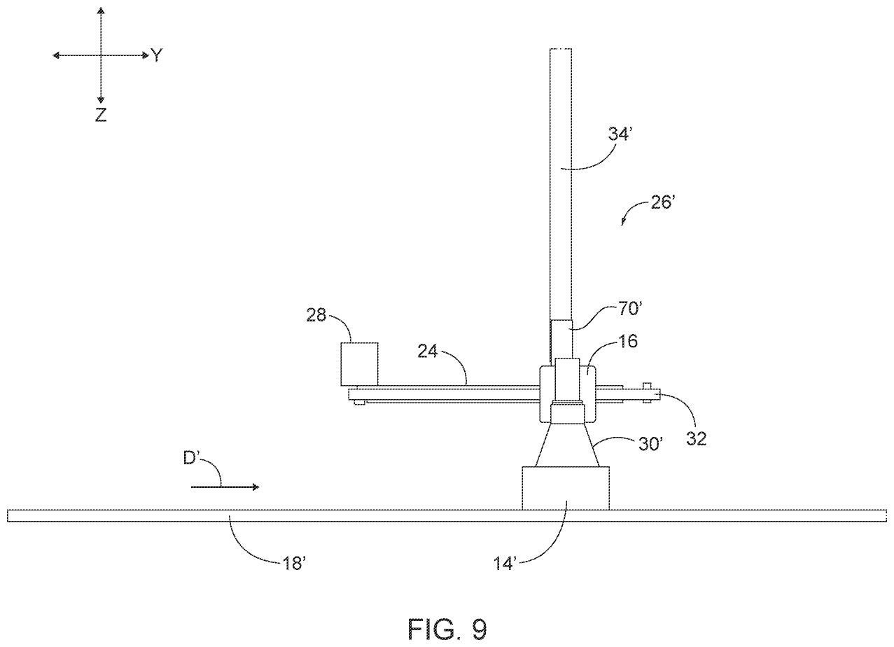

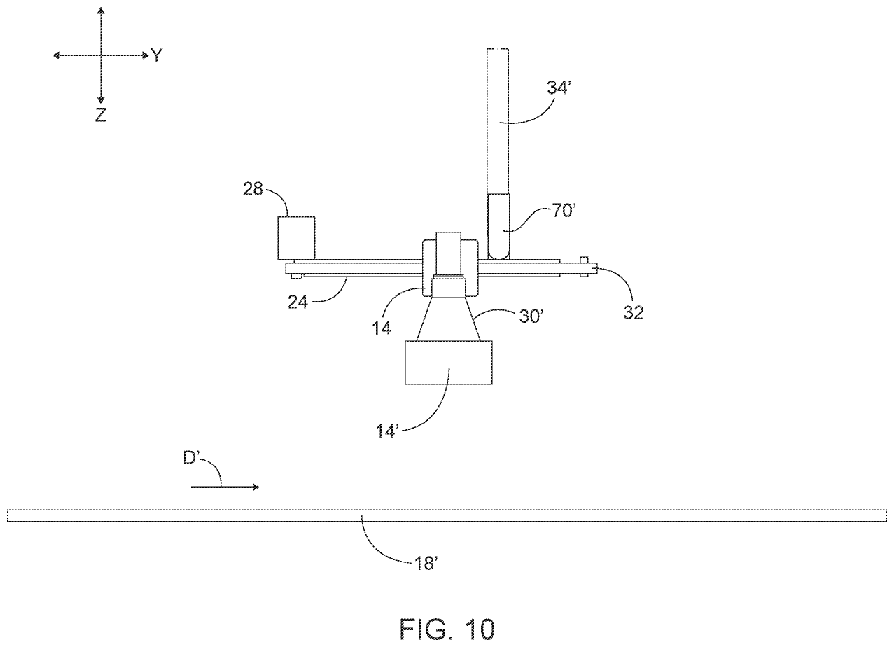

The end effector 30 is configured to make initial contact with the target object 14, when the end effector 30 reaches the predetermined position. After the end effector reaches the predetermined position, the catching mechanism 26 allows the end effector 30 to move in the same direction D1 as the target object 14 (e.g., in the Y-dimension) for a duration through means such as (but not limited to) motorized movement, or being dragged by friction against the target object 14. For example, as further discussed below, in some embodiments as shown in FIGS. 3-5, one or more linkage arms 50, or linkages, is positioned to allow the catching mechanism 26 to move in the Y-dimension. In another embodiment, as shown in FIGS. 6-10, the catching mechanism is movable relative to a rail that permits the end effector to move passively along the Y-dimension.

The catching mechanism 26 including the end effector 30 attached thereto is configured to allow the end effector 30 to move outside of the X-dimension and Z-dimension of the robot's frame. In other embodiments of this system, the Y-dimension catching mechanism may have a field of motion not defined by a linkage or rail system, such that it can move in one or more dimensions in order to make contact with moving target objects. In other embodiments of this system, the field of motion may be oriented in various dimensions or at various angles to allow the carriage to move in the same direction as the target object. Angles, in this context, are not necessarily in the Y-dimension or perpendicular to the Z-dimension pillar as depicted in this embodiment. In some embodiments of this system, the field of motion may not be linear (e.g., traveling in an arc). In some embodiments of this system, the catching mechanism may not require a field of motion at all, if it is able to successfully grasp the target object sufficiently quickly (e.g., by using very high-powered suction).

The catching mechanism's 26 free movement means that the end effector 30, after making initial contact with a target object 14, can move in the same direction D1 as the target object 14 for a long enough period of time to successfully pick up the target object 14 through suction, manual grasp, or the like. The size of the catching mechanism's 26 field of motion (for example, the length of the rail 34, 38, the range of movement of the linkage arms 50, the length of the linkage arms 50, etc.) can be determined based on the predetermined amount of time the end effector 30 must make sustained contact with a target object 14 to successfully grasp it; this is in turn is determined by variables including, but not limited to, the speed at which the target object 14 is moving, the material of the target object 14, and/or the shape of the target object 14.

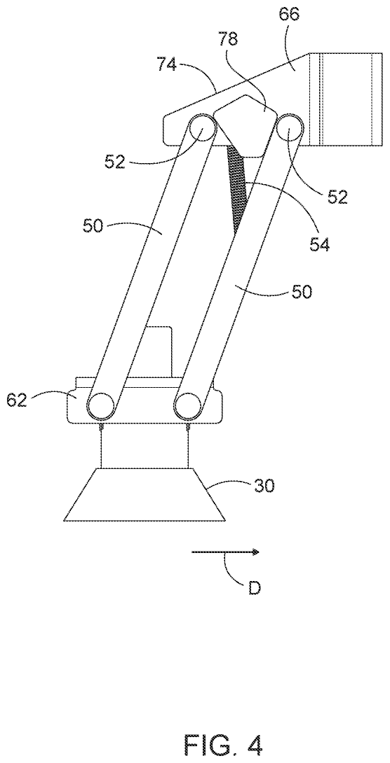

In order to achieve a precise position to make initial contact with a target object 14, the end effector 30 is positioned in a first or known starting position (see FIG. 4). To achieve a consistent starting position, the catching mechanism 26 may comprise a return mechanism. The purpose of the return mechanism is to return the end effector 30 to the same starting position after it has moved some distance by its contact with a target object 14. The catching mechanism 26 has a defined field of motion that permits the end effector 30 to move in at least one dimension. The return mechanism returns the catching mechanism 26 to a predetermined starting position when the catching mechanism 26 is not being moved by other forces in another direction.

In some embodiments, the catching mechanism 26 is capable of being moved, through automated or manual controls, on a one- or two-dimensional robotic frame, to the predetermined position in order to make initial contact with a stationary or moving target object 14, such that the end effector 30 attached to the catching mechanism 26 may sustain contact with the target object 14 for enough time to successfully grasp the target object 14 during the period of contact, and such that the return mechanism is capable of returning the end effector 30 to its starting position if the end effector 30 has moved positions while picking up the target object 14. In some embodiments, the catching mechanism may be affixed to a stationary or moveable frame that allows the catching mechanism to move to a predetermined position to make contact with a target object. In some constructions, the catching mechanism 26 is attached to a robotic system for movement of the catching mechanism to a predetermined position. In some constructions, the robotic system is able to move in the Z-dimension (up and down) and/or the X-dimension (side-to-side).

In some constructions, the robot 10 is capable of moving in the Z dimension (up-and-down) and the X dimension (side-to-side) and is configured to move the catching mechanism 26 to the predetermined position to allow the end effector 30 to make initial contact with the target object 14 moving in the front and rear dimension (the Y-dimension) when the target object 14 passes under the catching mechanism 26. Once initial contact is achieved, the system 10 relies on friction created by this contact to move passively in the direction that the target object 14 is moving, and to sustain contact for a long enough period of time to achieve a successful grasp. After the object has been picked up, the system 10 uses the return mechanism whose purpose is to return the end effector 30 to the predetermined starting position. This design results in a system that is significantly smaller, lighter-weight, and less expensive than existing robotic designs used to pick up moving objects.

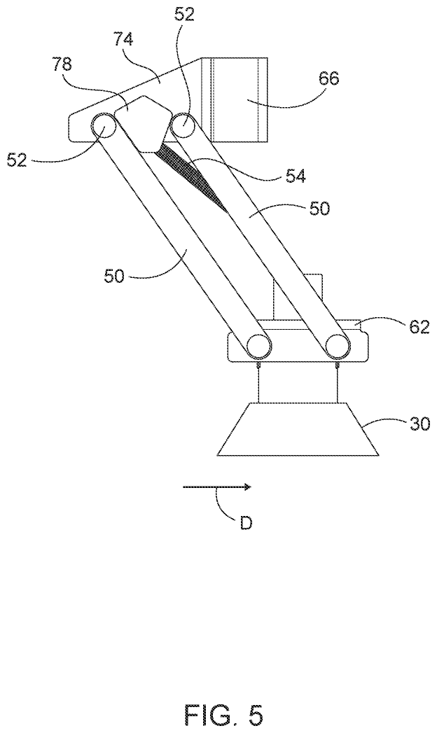

In one embodiment, as shown in FIG. 3, the return mechanism consists of one spring or a plurality of springs 54 that are attached to the end effector 30 for the purpose of being able to draw it back to its starting position. In the illustrated embodiment, the return mechanism includes a plurality of springs 54 coupled to the end effector 30. Accordingly, the catching mechanism 26 is configured as a mechanism that allows an end effector 30 to move in the direction D1 of the moving target object 14 (see FIG. 5), and a mechanism that returns the end effector 30 back to its starting position (see FIG. 4) after it makes successful contact with a moving target object. In some embodiments, the defined field of motion and return mechanism may be properties of the end effector 30 itself, such as an elastic suction cup that can be stretched in the direction of the moving target object 14, and that returns to its original shape once a successful grasp has been achieved.

During the time of prolonged contact, the end effector 30 can pick up the object 14 successfully, whether by vacuum suction, manual grasp, or the like. In the illustrated embodiment, the end effector 30 is depicted as a suction cup attached to an airflow system 58 via a port 62. The end effector may have other embodiments, including but not limited to one or multiple suction cups, claws, spikes, jamming grippers, and so on. Other end effectors may use controls other than an airflow system, such as another motor. In the embodiment depicted in FIG. 1, the airflow system 58 begins vacuum suction prior to or at the moment of the suction cup's 30 initial contact with the target object 14, and halts vacuum suction when the suction cup 30 is ready to release the object 14 at the intended destination.

Referring back to FIG. 3, the catching mechanism 26 includes the end effector 30 coupled to a platform 62. In addition, the catching mechanism 26 includes the plurality of linkages 50 movably coupled between the platform 62 and a base 66. The linkages 50 allow the platform 62 (and the end effector 30) to move in the Y-dimension. In this context, the Y-dimension refers to front to back from the frame of reference of FIG. 2, in the same direction D1 that the target object 14 is moving. As such, the platform 62 may be referred to herein as the Y-dimension platform 62. In other embodiments as discussed above, the catching mechanism 26 may permit movement of the platform 62 in multiple dimensions, which will allow the end effector 30 to pick up target objects 14 that are moving in a nonlinear fashion.

With reference to FIGS. 2 and 3, the base 66 of the catching mechanism 26 is coupled to the end portion 70 of the vertical or Z-dimension rail 34. In addition, the base 66 is oriented relative to the vertical rail to allow movement of the Y-dimension platform in the front-to-back direction (the Y-dimension). The linkage arms 50 attached to the Y-dimension hinged platform are the means by which the end effector 30, such as a suction cup, can move once it has made contact with the target object 14. The position and length of the linkage arms 50 is determined by the desired motion path and maximum distance traveled, which are determined by variables including, but not limited to, the direction and speed of the target objects' 14 movement. Depending on the end effector 30 used, additional systems may be required. In the case of a suction cup 30, the robotic system 10 may be attached to a system capable of creating vacuum suction, including but not limited to an air pump, a venturi pump, or an amplifier. The resulting air flow allows the suction cup 30 to pick up the target object 14 with which it makes contact. When the target object 14 is moved to its desired position by the rail system 22 (e.g., over a receptacle), the air pump turns off or reverses; the lack of vacuum suction allows the target object 14 to drop at the desired position.

With reference to FIGS. 3-5, the catching mechanism 26 includes the plurality of springs 54 operatively coupled to the plurality of linkages 50 or linkage arms. Each arm 50 is movably coupled to the base 66 and the platform 62 of the end effector 30 by a hinged connection 52. In the illustrated embodiment, the catching mechanism 26 includes four arms 50. Two arms 50 extend on one side 72 of the base 66, and the remaining two arms 50 extend on the opposite side 74 of the base 66. In addition, the illustrated catching mechanism 26 includes two springs 54 positioned on the two opposite sides 72, 74 of the base 66. In other embodiments, the catching mechanism 26 may include one or more linkage arms 50 and/or one or more springs 54 (e.g., three, four, etc.). Each spring 54 is coupled between the base 66 and one of the linkage arms 50. In other embodiments, the springs 54 may be attached to other components of the catching mechanism 26, including but not limited to two linkage arms 50, or between the platform 62 and the base 66 attaching the catching mechanism 26 to the Z-dimension rail 34.

Each of the springs 54 is configured to bias the end effector 30 toward the starting position. FIG. 4 illustrates the end effector 30 biased by the springs 54 in the starting (forward) position (e.g., to the left from the frame of reference of FIG. 4). Each spring 54 is tensioned to allow the end effector 30 to move with the movement of the target object 14 for a predetermined distance to the maximum extended position before the spring 54 contracts to move the end effector 30 toward the starting position again. FIG. 5 illustrates the end effector 30 in the maximum extended (rear) position (e.g., to the right from the frame of reference of FIG. 5). When not being moved (e.g., slid) forward, the Y-dimension platform 62 (i.e., having the end effector) is stationary at the starting position. Accordingly, the plurality of springs 54 represents one example of the return mechanism described herein. In other embodiments, the Y-dimension platform 62 can return to the starting position through controlled movement (e.g. via a motor, pneumatic cylinder, or the like) rather than through the release of potential energy (e.g., through the spring 54 that extends as the platform 62 is moved along its path of motion, and then contracts to its coiled position once the platform 62 is no longer being moved).

In FIG. 5, the end effector 30 is at the maximum extended position permitted by the catching mechanism 26. In some embodiments, the catching mechanism 26 may further include one or more stops. The stops define the catching mechanism's 26 field of movement. In other words, the one or more stops is configured to limit the movement of the end effector 30 in one or more dimensions (e.g., X-dimension, Y-dimension, Z-dimension, etc.). For example, in the event that a successful grasp is not achieved within the range of motion permitted by the movement of the hinge 52, a small plate 78 acts as a physical stop alongside the hinge 52 of the linkage arm 50 to prevent overextended movement that may damage the catching mechanism 26.

In addition, the one or more stops, such as the plate 78 or another stop, is positioned between linkage arms 50 of the plurality of linkages to limit or prevent the linkage arms 50 from rotating about or around the hinge points 52, thereby preventing the linkage arms 50 from moving further in the X-dimension. In other embodiments, the catching mechanism's 26 field of movement may be defined in multiple dimensions and/or by means other than a hinge, and the stops may be other physical stops or digital stops such as a limit switch.

In operation, in the embodiment depicted in FIG. 4, the catching mechanism 26 is positioned at the predetermined position (i.e., correct height) to make initial contact with the target object 14 by vertical (Z-dimension) and horizontal (X-dimension) movement of the Z-dimension rail 34 through automated or manual controls. However, the initial moment of contact may not be sufficient for the end effector 30 to successfully grasp the target object 14. In the embodiment depicted in FIG. 4, the end effector 30 is a suction cup which would be pulled at an angle in the direction D1 of the target object's 14 movement, preventing it from achieving a vacuum seal on the target object 14 that would be necessary to grasp the target object 14. However, because the linkage arms 50 allow for movement in the direction D1 that the target object 14 is traveling (in this case, the Y-dimension), the end effector's 30 initial contact with the target object 14 allows it to be dragged by the target object 14 for a sufficient amount of time to achieve a successful grasp. Once the object has been successfully grasped, the return mechanism, which is the plurality of springs 54, exerts force on the end effector 30 to pull it back to its predefined starting position. The force keeping the end effector 30 in its initial position via the spring 54 is less than the friction generated by the contact of the end effector 30 with the target object 14 on the conveyor belt 18. Therefore, the return mechanism is extended by the end effector's 30 movement in the Y-dimension. It should be noted that the return mechanism may have other embodiments, including but not limited to a motor or an air pump.

The catching mechanism 26 moves back to its starting position, having successfully grasped the target object 14. This is achieved through activation of the return mechanism, which moves the end effector 30 back to its initial position. In the illustrated embodiment, the return mechanism includes the springs 54; as the robot 10 lifts the end effector 30 upwards, the tension existing in the springs 54 is no longer counteracted by friction moving the end effector 30 in the Y-dimension, so the spring 54 contract and return the end effector 30 back to its initial position. However, this depiction is not to be interpreted in a limiting sense; the return mechanism may have many other embodiments, including but not limited to a single spring, a motor, or an air pump. In some embodiments, the robot's 10 upward movement may not be necessary to enable the end effector 30 to move back to its starting position.

Once the catching mechanism 26 is at rest in its starting position, successfully grasping the target object 14, the target object 14 can now be placed where intended. In one example use case, the catching mechanism 26 can be moved to the side (the X-dimension) by movement of the Z-dimension rail 34 across the X-dimension rail 38, such that the target object 14 can be released to its intended destination. Examples of intended destinations may include, but are not limited to, a receptacle, a slide, another conveyor belt, and so on.

FIG. 6 schematically illustrates an example of a centralized system (illustrated as electronic controller 100) for automatic control of the system according to some embodiments. In the embodiment illustrated, the electronic controller 100 includes an electronic processor 102, a memory 104, a communication interface 106, and input/output devices 108. The illustrated components, along with other various modules and components are coupled to each other by or through one or more control or data buses that enable communication therebetween. The use of control and data buses for the interconnection between and exchange of information among the various modules and components would be apparent to a person skilled in the art in view of the description provided herein.

The electronic processor 102 obtains and provides information (for example, from the memory 104 and/or the communication interface 106), and processes the information by executing one or more software instructions or modules, capable of being stored, for example, in a random access memory (“RAM”) area of the memory 102 or a read only memory (“ROM”) of the memory 104 or another non-transitory computer readable medium (not shown). The software can include firmware, one or more applications, program data, filters, rules, one or more program modules, and other executable instructions. The electronic processor 102 is configured to retrieve from the memory 104 and execute, among other things, software related to the control processes and methods described herein. For example, the electronic processor 102 may be configured to to determine the position of target object or the end effectors. The memory 104 can include one or more non-transitory computer-readable media, and includes a program storage area and a data storage area. The program storage area and the data storage area can include combinations of different types of memory, as described herein.

The communication interface 106 is configured to receive input and to provide system output. The communication interface 106 includes hardware for communicating over one or more wired or wireless communication networks or connections with, for example, the one or more sensors for determining the predetermined position of the end effector.

The input/output interface 108 may include one or more input mechanisms (for example, a touch screen, a microphone, a keypad, buttons, knobs, and the like), one or more output mechanisms (for example, a display, a printer, a speaker, and the like), or a combination thereof. The input/output interface 108 receives input from input devices actuated by a user and, in some embodiments, the one or more sensors of the communication interface 106 provides output to output devices with which the user interacts.

The controller 100 may include one or more sensors (including the one or more sensors for determining the predetermined position of the end effector) to determine one or more characteristics of the system 10 and operate the system based on data from the one or more sensors. The one or more sensors may include, but are not limited to, image sensors, audio sensors, pressure sensors, position sensors, and the like. The electronic controller 100 may be configured to utilize the one or more sensors to determine target object features of the target object 14 (for example, via objection detection/recognition methods) and accordingly operate the system 10 similar to as is described above (for example, operate a particular robot to grip the object). The controller 100 may cause the robotic frame to move the end effector 30 to the predetermined position in order to make initial contact with a stationary or moving target object 14. The controller 100 may cause the airflow system 58 to begin vacuum suction prior to or at the moment of the suction cup's 30 initial contact with the target object 14, and to halt vacuum suction when the suction cup 30 is ready to release the object 14 at the intended destination.

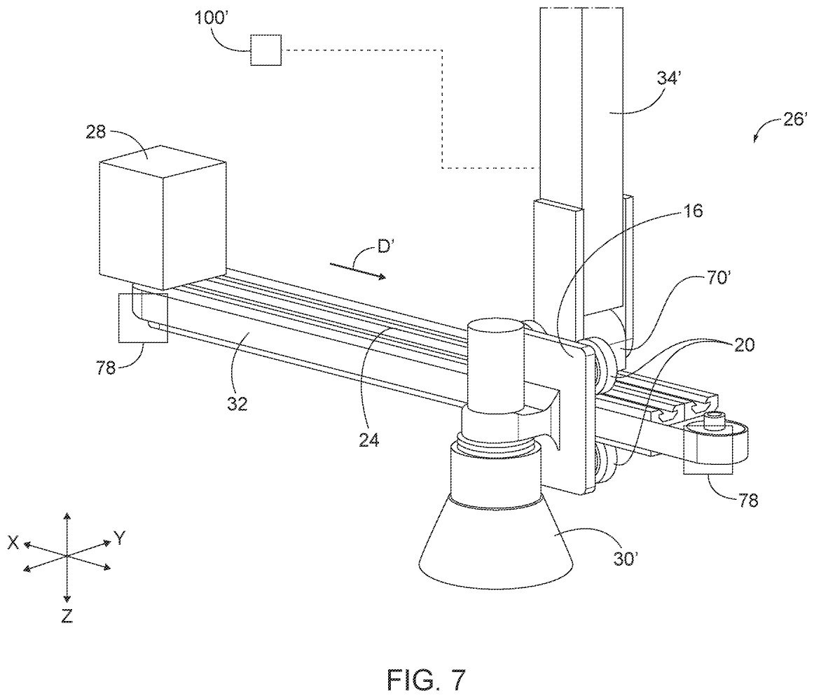

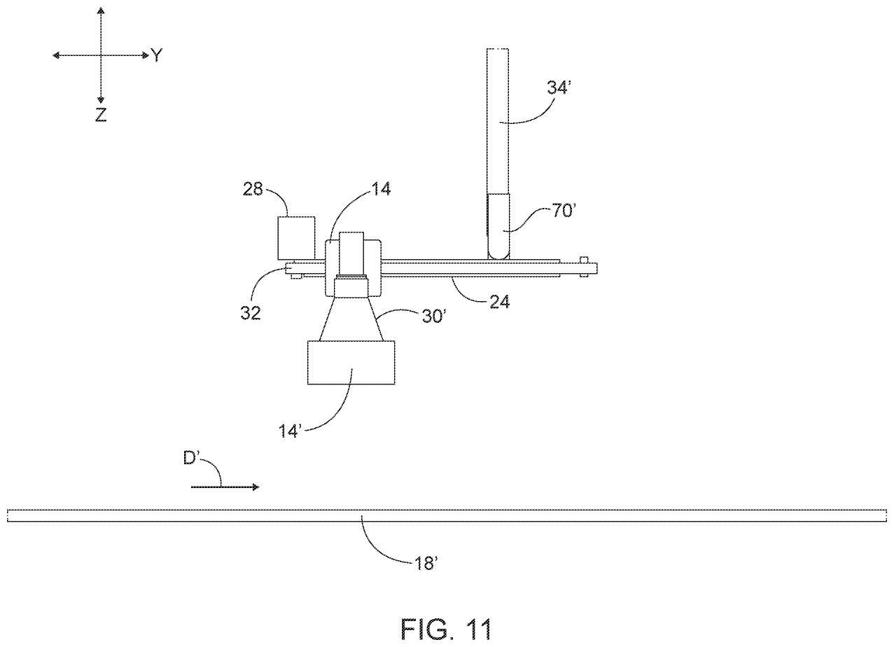

FIGS. 7-11 illustrate another embodiment of the catching mechanism 26′. Like parts are labeled in FIGS. 7-11 with the same reference numerals used above followed by the prime symbol (′) and need not be described again as reference is hereby made to the description above, while different features are described below. The catching mechanism 26′ is coupled to an end portion 70′ of the vertical or Z-dimension rail 34′. With reference to FIG. 7, the catching mechanism 26′ comprises an end effector 30′ affixed to a carriage 16. Rollers 20 allow the carriage 16 to slide along a rail 24 positioned in the Y-dimension. In this embodiment, the rail 24 ensures that the carriage 16 only moves in one dimension. The catching mechanism 26′ further includes a motor 28 and pulley 32 configuration operatively coupled to the carriage 16 for movement of the carriage 16 along the rail 24. The catching mechanism 26′ includes a return mechanism which includes the motor 28 and the pulley 32 coupled to the end effector 30′. The motor 28 rotates the pulley 32 to move the carriage 32 in the Y-dimension. FIG. 7 depicts an embodiment of the return mechanism at maximum extension. In the illustrated embodiment, the catching mechanism 26′ may further include stops that define the catching mechanism's 26′ field of movement; for example, these stops may comprise plates 78′ at each end of the rail 24 that prevent the carriage 16 from slipping off of the rail 24.

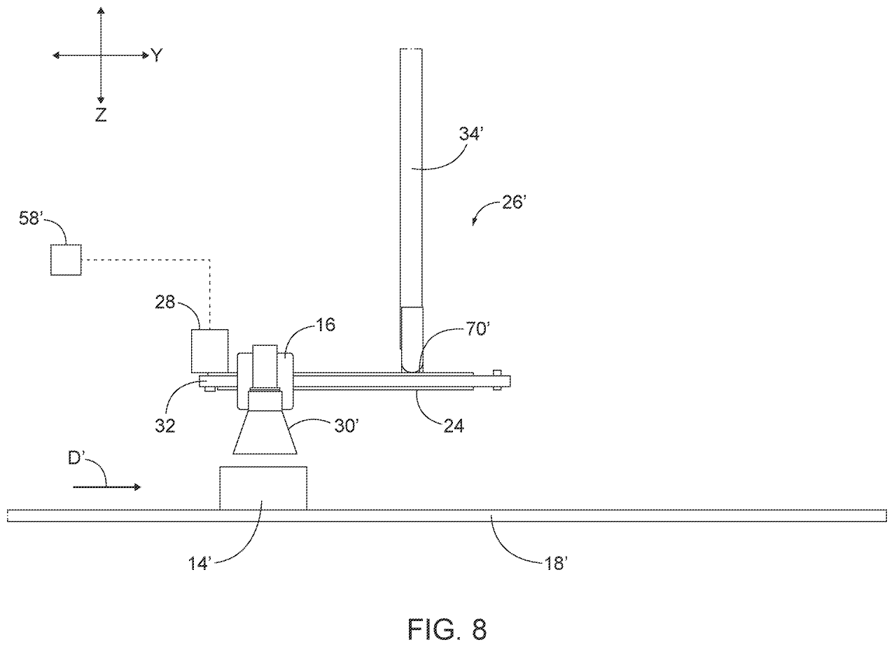

FIGS. 8-11 illustrate the catching mechanism 26′ moving from a starting position to a maximum extending position, and then returning again to the starting position. Accordingly, FIGS. 8-11 illustrate one embodiment of a process by which the catching mechanism 26′ picks up a target object 14′ moving in a direction D2. In this depiction, the robotic system relies on controlled movement of the end effector 30′ in the X- and Z-dimension, and passive or kinetic movement in the Y-dimension by sustained contact with the target object. The depiction of this process is illustrative, and should not be interpreted in a limiting sense; other embodiments may use different means to pick up a target object 14′.

Using the approach described above, a robotic system is able to pick objects from a moving belt 18′ despite having a significantly narrower profile and simpler frame than robotic systems utilized in prior art. Due to its smaller size and lower cost, the robotic system described herein is easier and cheaper to fabricate and install. As a result, it affords its users substantial savings in time, space, and cost compared to robotic systems described in prior art.

In one embodiment, a frame of a robot comprises two carriages, each attached to a rail. One carriage is capable of sliding up and down on a vertical rail (the Z-dimension); the carriage is attached to another carriage capable of sliding side to side on a horizontal rail (the X-dimension), which in practice allows the vertical rail to move both up-and-down and side-to-side. In this embodiment, the movement of both carriages is powered by motorized controls.

The length of the horizontal X-dimension rail can be determined by the sum of the width of the field in which target items may appear (for example, the width of a conveyor belt) and the distance to the drop-off point for the picked-up object.

The robotic system described above is able to (1) move the end effector to a position to make initial contact with a target object, (2) allow the end effector to travel alongside the target object if needed, such that it can make contact for a sustained enough period of time to achieve a successful grasp, (3) pick up the object once it has achieved a successful grasp, and (4) drop the object in a desired location.

The narrow profile of the embodiments shown herein affords the ability to sequentially install two or more such robots in the same amount of space that might be occupied by a single robot sorter of other types. The ability to install multiple sorting robots of the embodiments shown herein sequentially unlocks opportunities for novel sorting systems that can pick up a larger volume of objects and/or a more heterogeneous array of objects than attained by other robotic systems, while also providing space and cost savings over other robotic systems.

A basic embodiment of a multi-robot sorting system involves installing two or more sorting robots, as described above, sequentially along a conveyor belt. In this multi-robot embodiment, as in the single-robot embodiment described earlier, the controls that determine the position of the end effector(s) may be automatic or manual. In the case of automatic controls, a single centralized system may be capable of coordinating and optimizing the movements of the two or more robots. A multi-robot sorting system as described herein offers improved ability to pick up target objects traveling in the Y-dimension despite the robot itself being unable to move in the Y-dimension, because the usage of multiple catching mechanisms allow the multi-robot sorting system more instances to engage with a target object along the object's path of motion than a single robotic sorter alone. A multi-robot sorting system that uses robots of the design described above also affords cost and space savings over robotic sorting systems of the prior art.

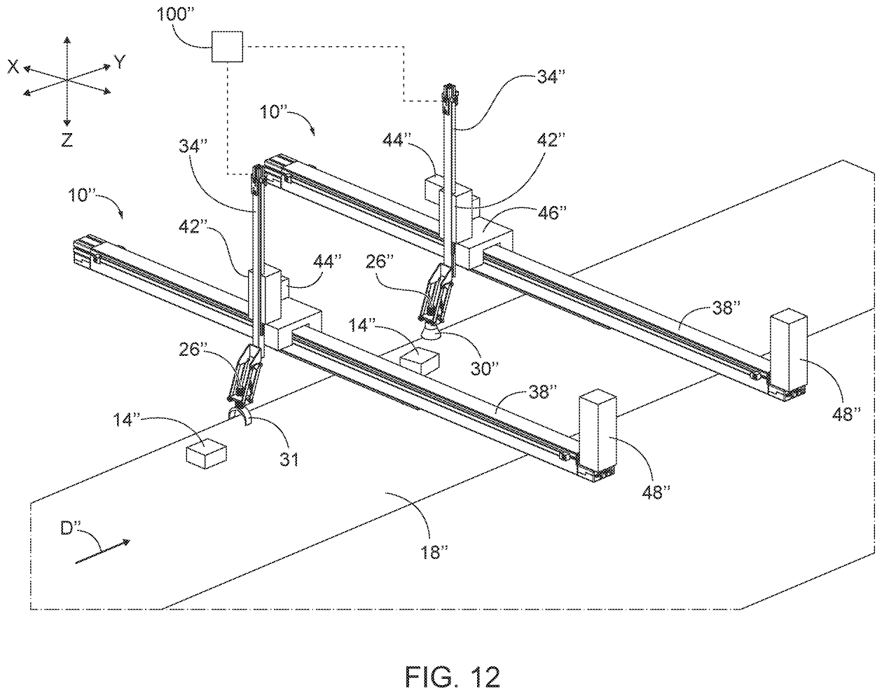

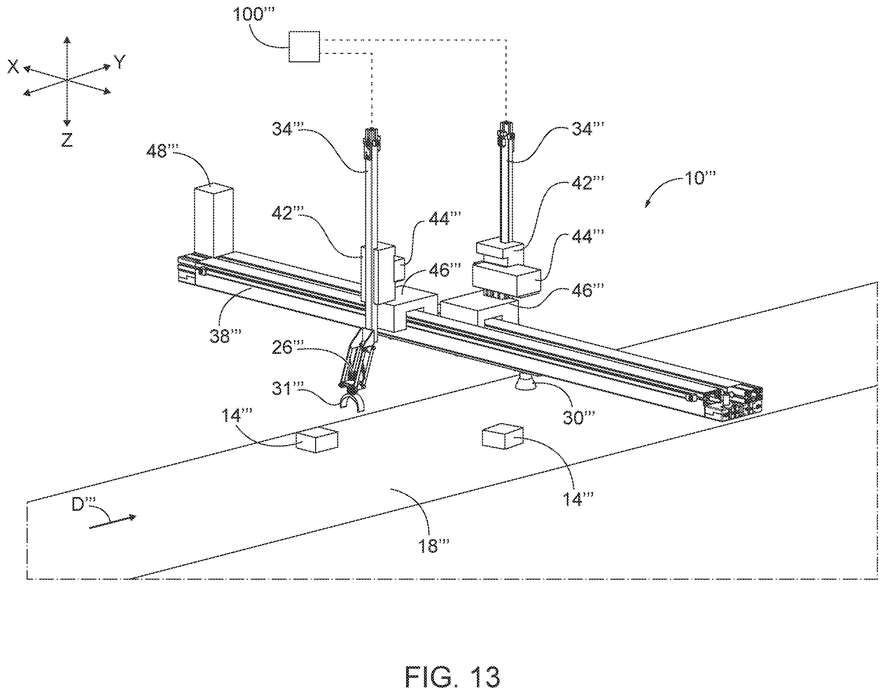

With reference to FIGS. 12-13, a more advanced embodiment of a multi-robot sorting system. This arrangement increases the maximum volume of objects the system can pick up compared to a single robot, and also increases the heterogeneity of objects that the system can pick up. Different end effectors are differentially suited to successfully picking up certain classes of objects depending on variables such as (but not limited to) the target object's size, material, and shape. For example, an array of one or more suction cups may be more successful at picking up flat and lightweight objects; a claw may be more successful at picking up three-dimensional and heavy objects. This example is intended to be illustrative; depending on the design of a specific array of suction cups and a specific claw, the opposite could also be true.

In some constructions, a system in which two or more robots 10 as described above are installed in sequence; in which the robots 10 may have as attachments different combinations of one or more types of end effectors 30 in different orders; and in which one or more of the robots 10 may be assigned to automatically or manually pick up a target object 14.

FIG. 12 illustrates an example embodiment of a multi-robot sorting system. In the depicted embodiment, two sorting robots 10″, or robotic systems, as described above are installed sequentially along a conveyor belt 18″; each robot 10″ has a different end effector (one suction cup 30″, or first end effector, and one claw 31, or second end effector). The two sorting robotic systems 10″ include a first robotic system 10″ and a second robotic system 10″. The multi-robot sorting system for picking up objects includes a first robotic system 10″ and the first end effector 30″. The multi-robot sorting system also includes a second robotic system 10″ having the second end effector 31. The second end effector is different from the first end effector. A target object 14″ can be identified and classified through automatic or manual assignment, and then the best-suited robot 10″ can be delegated the task of picking up the object 14″. In other embodiments, the same type of end effector may be attached to each Z-dimension rail 34″, and other types of end effectors may be used, such as a spike or jamming gripper.

FIG. 13 illustrates another example embodiment of a multi-robot sorting system, in which a robotic system uses two Z-dimension rails 34′″ attached to a single X-dimension rail 38′″; each Z-dimension rail 34′″ manipulates its own catching mechanism 26′″ with an associated end effector, in this case again a suction cup 30′″ and a claw 31′″. A target object 14′″ can be identified and classified through automatic or manual assignment, and then the best-suited end effector can be delegated the task of picking up the object 14′″. Other embodiments are equally possible.

A multi-robot sorting system allows the use of more than one end effector. As a result, a full array of end effectors can be utilized within a multi-robot system, allowing the system to pick up significantly more types of objects. As in previously described embodiments, the controls that determine the position of the end effectors may be automatic or manual. If relying on automatic controls, a single centralized system may be capable of coordinating and optimizing the movements of the two or more robots. In one embodiment, a single centralized system, or electronic controller 100″, 100′″, uses a computerized algorithm to detect target object 14″, 14′″, features such as size, shape, material, and position. The target object features can be analyzed to determine which robot or robots within a multi-robot system should be assigned a task to pick up the target object 14″, 14′″. The assignment determination can be based on any number of considerations, including which end effector is best suited to grip the object, which robot is positioned to reach the object 14″, 14′″ the fastest, and so on.

In a multi-robot sorting system, regardless of the number of robots or the combination of end effectors used, the system relies on an external process (automated or manual) for selecting the robot best-suited to picking up a given target object. The selection of a best-suited robot may be determined by assessing such object-specific variables including but not limited to the object's size, shape, position, and material; and such robot-specific variables including but not limited to the robot's position in the sequence, the position of the robot's end effectors along the frame, or the design of the end effectors themselves.

Embodiments described above may rely on automated or manual controls to move the catching mechanism to the predetermined position. Embodiments may also use different combinations of motorized and passive movement to move the end effector. Example embodiments include, but are not limited to, three dimensions of controlled movement such that the end effector is movable to the predetermined position to allow initial grasping of the target object, and then sustain movement of the end effector alongside the target object in order to achieve a successful grasp. In other embodiments, two dimensions of controlled movement is provided to allow initial grasping of the target object, and then one dimension of passive movement is provided, in which the end effector is moved (e.g., pulled) in the direction of the target object by making initial contact with the object.

Although the invention has been described in detail with reference to certain preferred constructions, variations and modifications exist within the scope and spirit of one or more independent aspects of the invention as described.

What is claimed is:

1. A catching mechanism comprising:
an end effector; and
a return mechanism coupled to the end effector,
wherein the catching mechanism has a defined field of motion that permits the end effector to move in at least one dimension, and wherein the return mechanism is configured to return the catching mechanism to a predetermined starting position in which the catching mechanism is not being moved by a force away from the predetermined starting position.

2. The catching mechanism of claim 1, wherein the end effector includes at least one of a suction cup, claw, spike and a jamming gripper.

3. A robotic system for picking up a target object, the robotic system comprising:
the catching mechanism of claim 1; and
a robotic frame configured to move the at least one catching mechanism to a predetermined position in order to make initial contact with a target object.

4. A multi-robot sorting system for picking up objects, the system comprising:
the robotic system of claim 3, the robotic system being a first robotic system and the end effector being a first end effector; and
a second robotic system having a second end effector.

5. The multi-robot sorting system of claim 4, further comprising a centralized system configured to detect a target object feature of the target object and configured to assign a task of picking up the object to one of the first robotic system or the second robotic system.

6. The catching mechanism of claim 1, wherein the return mechanism includes a plurality of springs coupled to the end effector.

7. The catching mechanism of claim 1, wherein the return mechanism includes a motor and a pulley coupled to the end effector.

8. The catching mechanism of claim 1, wherein the catching mechanism includes a base coupled to the second rail, a platform coupled to the end effector, and a plurality of linkages movably coupled to the platform and the base by hinged connections.

9. The catching mechanism of claim 1, wherein the catching mechanism includes a carriage slidable along a rail, and wherein the end effector is affixed to the carriage.

10. A robotic system for picking up objects, the robotic grasping system comprising:
a catching mechanism including a return mechanism and an end effector movable from a starting position when the end effector makes contact with a target object;
a robotic frame by which the catching mechanism is moved to a predetermined position such that the catching mechanism can sustain contact with the target object for a period of time to grasp the target object,
wherein the return mechanism is configured to return the catching mechanism back to the starting position if the end effector moves during the sustained contact with the target object.

11. The robotic system of claim 10, wherein the robotic frame is a two-dimensional robotic frame.

12. The robotic system of claim 10, wherein the end effector is movable in first and second dimensions of controlled movement on the frame, and wherein the end effector is passively movable in a third dimension by the sustained contact with the target object.

13. A multi-robot sorting system for picking up objects, the system comprising:
the robotic system of claim 10, the robotic system being a first robotic system and the end effector being a first end effector; and
a second robotic system having a second end effector.

14. The multi-robot sorting system of claim 13, further comprising a centralized system configured to detect a target object feature of the target object and configured to assign a task of picking up the target object to one of the first robotic system or the second robotic system.

15. The robotic grasping system of claim 10, wherein the end effector includes at least one of a suction cup, a claw, a spike, a jamming gripper, and a mechanism configured for grasping objects.

16. A robotic grasping system for picking up objects, the robotic grasping system comprising:
a first rail;
a first carriage movably mounted to the first rail, the first carriage being movable in a first dimension;
a second carriage mounted to the first carriage;
a second rail movably mounted to the second carriage, the second rail being movable in a second dimension that is different from the first dimension;
a catching mechanism coupled to an end portion of the second rail and configured to engage with a target object moving in a third dimension which is different from the first dimension and the second dimension.

17. The catching mechanism of claim 16, wherein the second rail is unable to move in the third dimension.

18. The catching mechanism of claim 17, wherein the first rail is unable to move in the third dimension.

19. A multi-robot sorting system for picking up objects, the system comprising:
the robotic grasping system of claim 16, the robotic system being a first robotic grasping system and the end effector being a first end effector; and
a second robotic grasping system having a second end effector, the second end effector being different from the first end effector.

20. The multi-robot sorting system of claim 16, further comprising a centralized system configured to detect a target object feature of the target object and configured to assign a task of picking up the target object to one of the first robotic grasping system or the second robotic grasping system.
